(19) United States
(12) Patent Application Publication
(10) Pub. No.: US 2024/0394713 A1
(43) Pub. Date: Nov. 28, 2024

(54) SYSTEMS AND METHODS FOR PROGRAMMATICALLY GENERATING DECISION RULES FOR ALERT DETECTION ENGINES USING MACHINE LEARNING OPERATIONS

(71) Applicant: Actimize LTD., Ra’anana (IL)

(72) Inventors: Nitzan TAL, Modiin (IL); Ori SNIR, Hoboken, NJ (US); Yonit MARCUS, Rehovot (IL); Amir Shachar, Holon (IL)

(21) Appl. No.: 18/322,100

(22) Filed: May 23, 2023

(51) Int. Cl. G06Q 20/40

(52) U.S. Cl. CPC G06Q 20/4016

(57) ABSTRACT

A rule training system and methods are provided that are configured to automatically generate machine learning (ML) rules for intelligent decision-making by a policy manager platform. The system includes a processor and a computer readable medium operably coupled thereto, the computer readable medium comprising a plurality of instructions stored in association therewith that are accessible to, and executable by, the processor, to perform rule training operations which include accessing rule training data, iteratively generating a plurality of decision rules based on the rule training data and a plurality of ML model training techniques, testing each of the plurality of decision rules, filtering the plurality of decision rules by corresponding performances, selecting a set of the plurality of decision rules based on alert metrics, evaluating the set of the plurality of decision rules, and generating a decision ruleset for the ML task.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to artificial intelligence (AI) and machine learning (ML) systems and models, such as those that may be used for fraud detection with financial institutions, and more specifically to a system and method for programmatically generating decision rules for alert detection using ML operations.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized (or be conventional or well-known) in the prior art. The subject matter in the background section merely represents different approaches, which in and of themselves may also be inventions.

Banks and other financial institutions may utilize ML models and engines to detect instances of fraud and implement anti-fraud solutions. In traditional ML model training, a model is trained using historical data and may provide a classification or other predictive output that attempts to classify input data based on knowledge of the past data. In order to make use of an ML model in financial technologies, fraud, risk analysis, anti-financial crime systems, and other ML systems, a strategy (e.g., a decision rule and/or ruleset, such as a bundle of individual rules that may work together, in synchronization or series, and/or for individual contributions) may be required to be established to determine a set of conditions that, when met in conjunction with the ML model's risk score or other output, causes an alert to be generated, a payment to be blocked or delayed, an authentication step-up to be issued to the user/customer, or the like. To generate these rules and rulesets, users and entities, such as fraud detection teams, data scientists, and the like, may primarily rely on experience and intelligence of such users and teams to create and deploy these rules, as well as identify the best combinations of conditions that maximize fraud detection and minimize false positives that cause customer friction. This may be a complicated task and typically requires a significant amount of data to research, test, and deploy such rules. Moreover, most financial institutions may not have internal “housekeeping” practices in place for risk analysis and fraud detection systems, including their corresponding rules and effectiveness of such rules. Thus, the rules created today as part of their business may, over time, cause unnecessary alerts, become obsolete, or otherwise age and be less valuable during fraud detection while utilizing unnecessary computing resources. Such outdated rules begin to create more noise in the fraud detection systems than contribute to value. Similarly, other ML systems and models suffer from experience-based generation of static rules and rulesets, which are not adaptive to changing data, patterns, and technology and rely mainly on the expertise of data scientists and rule generators.

Thus, decision rules and ruleset generation for ML models may present a major obstacle to sustaining robust and efficient ML engines. In predictive analytics and ML operations, rule creation strategies and systems may not maximize a value detection rate (VDR) instead of a detection rate (DR) of the rules in issuing alerts. VDR may correspond to a factor of the value of such rule in issuing alerts and performing fraud detection, and not just the DR alone. Further, rule generation techniques using MIL, conventionally require labeled data and are supervised, which may take significant time when generating training data. For example, these techniques may not use unsupervised ML algorithms and techniques that are trained using unlabeled data that does not require time in maturing and providing labels to data (e.g., fraud labels, which may not occur until much later when fraud is detected by the bank's personnel). Finally, without optimizing for selection of a set of rules given a scenario or task and maximum alert rate or other constraints and alert metrics, an optimal output may not be provided. Thus, there is a need to develop a system for programmatically generating decision rules for deployment with ML models and engines to increase and sustain efficient operation of such models and engines.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion. In the figures, elements having the same designations have the same or similar functions.

FIG. 1 is a simplified block diagram of a networked environment suitable for implementing the processes described herein according to an embodiment.

FIG. 2 is a simplified diagram of a computing pipeline to programmatically generate decision rules using ML operations according to some embodiments.

FIG. 3 is a simplified diagram of modular operations executed by an ML engine for programmatically generating decision rules according to some embodiments.

FIG. 4A is a simplified diagram of ML operations using labeled data with supervised ML techniques and unlabeled data with unsupervised ML techniques for decision rule generation according to some embodiments.

FIG. 4B is a simplified diagram of ruleset selection using a knapsack problem solution according to some embodiments.

FIG. 5 is a simplified diagram of an exemplary flowchart for programmatically generating decision rules and corresponding rulesets using machine learning operations according to some embodiments.

FIG. 6 is a simplified diagram of a computing device according to some embodiments.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the scope of this description and the claims. In some instances, well-known circuits, structures, or techniques have not been shown or described in detail as these are known to one of ordinary skill in the art.

In this description, specific details are set forth describing some embodiments consistent with the present disclosure. Numerous specific details are set forth in order to provide a thorough understanding of the embodiments. It will be apparent, however, to one of ordinary skill in the art that some embodiments may be practiced without some or all of these specific details. The specific embodiments disclosed herein are meant to be illustrative but not limiting. One of ordinary skill in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In order to programmatically generate decision rules used for fraud detection and other ML engines, supervised and unsupervised ML pipelines and processing flows may utilize a set of training data to generate and recommend rules and rulesets as discussed herein. ML models may be built on different tenants of a fraud detection and/or ML model training system, such as different financial institutions, and using historical or past available rule training data received for the particular tenant and/or for multiple or different tenants. The ML operations and system may utilize the rule training data to identify these decision rules and combinations of rules (e.g., rulesets that implement or detect a particular outcome based on the occurrence of multiple instances and/or trigger conditions for different rules) in an automatic, data-driven manner, thus allowing the ML system to generate rules and rulesets with more accurate fraud strategies. The ML system for decision rule generation may further reduce the dependency on a human factor for rule generation and reduce manual errors related to rule simulation, rule coding, or rule deployment. By using an ML model, template, and processing pipeline for decision rule generation, customers and tenants of the fraud detection system or other service provider may automate decision rules discovery and rule selection processes, while offloading the complicated and lengthy data analysis tasks required during rule testing, deployment, and lifecycle monitoring (e.g., determination of outdated or poorly performing rules based on data changes, patterns, and behaviors over time) to increase computational efficiency in generating, maintaining, and updating such ML models and rules.

ML models and decision rules may be required to adapt to evolving trends and new patterns in data. A proper mechanism for updating utilizes real data streams, live data, and/or recently received data, which may be unlabeled or may not be properly used over time to update decision rules for AI systems (e.g., rule-based engines, ML models and engines, neural networks (NNs), and the like). This could be steady changes over time, periodic or recurring changes (e.g., based on seasonal data), sudden sweeping changes (e.g., caused by a new event or occurrence, such as COVID-19 or other regional or global occurrence), or any combination thereof. As described herein, the ML pipeline for decision rule generation may allow strategy and information technology (IT) teams to run periodic rule updates and clean up processes so that their set of rules may be kept up to date at any given point, thereby preventing or reducing outdated, redundant, or overlapping rules in the fraud detection or other ML system.

Initially, the ML operations and pipeline for programmatic decision rule generation (e.g., using an ML processing flow and based on ML models) may be used to generate decision rules using history data selected as the training data for decision rules and rulesets. One or more ML models and techniques may be deployed into a test and/or production computing environment for decision rule generation where training data is received. Labels may be provided, or the data may remain unlabeled for unsupervised ML models. For example, with transaction data used for rule generation for a fraud detection system, the training data may include transaction data that represents valid and fraudulent transactions, which may be labeled with valid and/or fraudulent transactions or may be unlabeled. Based on the labeled or unlabeled transactions, as well as any additional training data, preprocessing of the data may be performed. The data may then be provided to a supervised or unsupervised ML engine (e.g., for labeled or unlabeled data, respectively) employing one or more respective ML models and/or algorithms for decision rule discovery and generation. These ML engines may provide decision rule training and selection of ML branches, decision trees, scoring, and the like for decision rules that provide optimal results. Rule training may implement an iterative algorithm and approach on the training data set where a refined data set is used after removing fraudulent data records that were classified correctly by the rules selected in the current iteration. Thus, the refined data set may improve on errors from the previous iteration in missing identifications of positive samples.

Once an initial set of decision rules are generated, ML operations for the ML pipeline for decision rule selection individually and/or collectively in rulesets may be performed. Selection may include filtering, which may be performed by calculating an individual performance of each rule that has been generated and filtering out those rules that are underperforming. Underperformance may be judged on different metrics, such as an alert rate and a threshold target alert rate (which may be user defined, preset by the system or ML task, or dynamic depending on the task, action to be executed, rule training data, etc.). Unstable and/or correlated rules (e.g., overlapping, which may be for the same or similar alert detection task and/or data, such as transaction amount, etc.) may be removed. Further, selection may utilize feature importance scores to rank rules according to their quality, for example, using XGBoost feature importance for supervised ML algorithms or isolation forest feature importance's with “SHAPley” or “Shapley” (SHAP) values for unsupervised ML algorithms. Filtering and selection are performed also on corrective rules, which may serve for optimization later and may be introduced during iterative training and decision rules generation. Corrective rules may correspond to rules that point on legitimate transactions.

Rule selection may continue by creating rulesets from subsets of qualifying rules based on a predefined alert rate that implements an automated process for handling the knapsack problem with dynamic programming. The knapsack problem generally refers to combinatorial optimization problems where a fixed-size constraint or threshold (e.g., on an alert rate of a ruleset) limits selection of items (e.g., rules in a ruleset that have individual alert rates), thereby requiring significant resource allocation for selection optimization. After rule selection and/or creation of one or more rulesets for alert detection and output (e.g., based on rule triggering and AI scoring or decision-making from input data), further evaluation and application operations of those rulesets may be applied. This may include evaluating selected rules in a ruleset both marginally and collectively, where performance of the rules in alerting for the required task is evaluated with collective performance to prevent overlap and/or underperformance. Recommendations of programmatically generated rulesets may then be provided to users, administrators, data scientists, security or IT teams, and the like, which may include information for rule performances and alert rates for further ruleset selection and application to an ML task by users.

The embodiments described herein provide methods, computer program products, and computer database systems for an ML system for determining and programmatically generating decision rules used by ML alert detection and other ML systems using ML algorithms, models, and systems. A financial institution or other service provider system may therefore include a fraud detection system that may access different transaction data sets and detect fraud using programmatically generated decision rules. The system may generate, select, evaluate, and apply recommendations on decision rules and rulesets in an automated and programmatic manner without manual efforts and user intervention, which may be done using ML algorithms, models, and systems. The system may then alert on fraud or other ML task using such decision rules in intelligent fraud detection or other predictive analytic systems.

According to some embodiments, in an ML system accessible by a plurality of separate and distinct organizations, ML algorithms, features, and models are provided for identifying, generating, and providing decision rules in a programmatic environment and manner, thereby providing faster, more efficient, and more precise decision rules implemented in AI systems.

### Example Environment

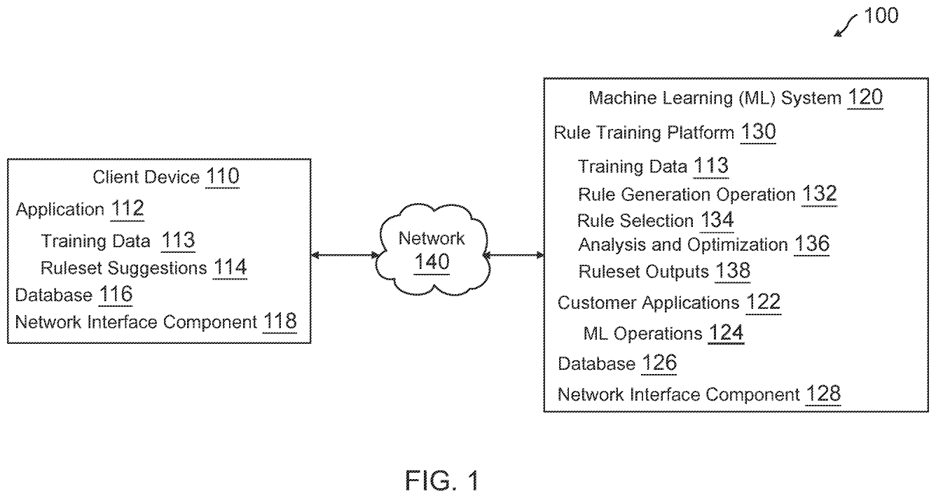

The system and methods of the present disclosure can include, incorporate, or operate in conjunction with or in the environment of an ML engine, model, and intelligent system, which may include an ML or other AI computing architecture that includes a programmatic decision rule generation system. FIG. 1 is a block diagram of a networked environment 100 suitable for implementing the processes described herein according to an embodiment. As shown, environment 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided, by such devices and/or servers may be combined or separated for a given embodiment and may be performed by a greater number or fewer number of devices and/or servers. For example, ML models, NNs, and other AI architectures have been developed to improve predictive analysis and classifications by systems in a manner similar to human decision-making, which increases efficiency and speed in performing predictive analysis of transaction data sets and/or other data requiring machine predictions, classifications, and/or analysis. One or more devices and/or servers may be operated and/or maintained by the same or different entities.

FIG. 1 illustrates a block diagram of an example environment 100 according to some embodiments. Environment 100 may include a client device 110 and an ML system 120 that interact over a network 140 to provide intelligent detection and/or prevention of fraud or other predictive classifications through one or more ML models that utilize decision rules and rulesets generated programmatically using ML operations as discussed herein. In other embodiments, environment 100 may not have all of the components listed and/or may have other elements instead of, or in addition to, those listed above. In some embodiments, environment 100 is an environment in which programmatic rule generation may be performed through an ML or other AI system. As illustrated in FIG. 1, ML system 120 might interact via a network 140 with client device 110, which generates, provides, and outputs decision rules and/or rulesets for use with ML models and engines during intelligent classifications, outputs, scoring, decision-making, and/or predictions.

ML system 120 may be utilized to determine decision rules and rulesets for an ML model used by client device 110 that implements, provides alerts and/or notifications for, and/or executes an ML task or operation in response to particular input data and a corresponding ML engine that scores, classifies, or otherwise processes that data. For example, client device 110 may include an application 112 that provides training data 113 for rule training and receives ruleset suggestions 114 for decision rules and rulesets generated from training data 113. ML system 120 includes a rule training platform 130 for programmatic rule generation using ML operations. ML system 120 further includes customer applications 122 to provide computing services to customers, tenants, and other users or entities accessing and utilizing ML system 120. In this regard, customer applications 122 may include ML engines 124 that implement decision rules and rulesets output to client device 110 with ruleset suggestions 114 that have been selected and implemented for use with customer application 122, for example, to provide intelligent classification, decision-making, predictions, and the like. However, in other embodiments, such selected rules and rulesets from ruleset suggestions 114 may be utilized with other ML systems and models, such as those managed by separate computing systems, servers, and/or devices (e.g., tenant-specific or controlled servers and/or server systems that may be separate from the programmatic rule generation discussed herein).

In this regard, customer applications 122 of client device 110 may include ML engines 124 utilizing ML models that alert and/or execute an automated computing task, action, or operation based on decision rules generated using training data 113 by rule training platform 130. ML engines 124 may implement decision rules from ML models (e.g., decision trees and corresponding branches) trained from training data 113, which may correspond to historical data used to provide a basis or background to each corresponding ML model. This may include performing feature engineering and/or selection of features associated with features or variables used by ML models, identifying data for features or variables in training data 113, and using one or more ML algorithms, operations, or the like (e.g., including configuring decision trees, weights, activation functions, input/hidden/output layers, and the like). After initial training of ML models using supervised or unsupervised ML algorithms (or combinations thereof), branches from decision trees may be used to determine decision rules usable in a production computing environment to predict alerts, execute an action, classify data, or otherwise provide alert detection for instances and/or occurrences of particular data (e.g., whether input transaction data indicates fraud or not).

Rule training platform 130 may therefore implement an ML pipeline and/or processing flow which seeks to a.) discover ML decision rules used for actionable tasks, actions, or operations based on ML models, b.) select rules and/or rulesets from those discovered rules based on filtering and selection criteria and procedures, c.) evaluate the performance of the selected rules and/or rulesets, and d.) provide recommendations on the selected rules and rulesets with evaluations, performances, tasks and actions for the rules and/or rulesets. Rule training platform 130 therefore includes a rule generation operation 132 configured to act on and process training data 113, which may include labeled data, unlabeled data, or a combination thereof. Labeled data may be processed using supervised ML algorithms and models, such as training with optimized XGBoost models with an iterative data-refinement procedure. Unlabeled data may be processed using unsupervised ML algorithms and models, such as training with isolation forest models based on a hyperparameter grid, in a similar iterative data-refinement manner. However, other supervised techniques (e.g., adaptive boosting (ADABoost) or similar) and/or unsupervised techniques may be used. Branches of the ML models and/or decision trees (or other ML model selection criteria, such as clusters, cluster affiliations and/or combinations, etc.) may be selected for optimal results by rule generation operation 132. Optimal results in an unsupervised environment may correspond to those results that, when implemented, provide the lowest rate of false positives as determined by the alert or case investigator.

Rule training platform 130 further includes a rule selection 134 that selects rules individually and/or for rulesets based on individual performances, removal of unstable and/or correlated rules, and other selection operations. Rule selection 134 may include filtering of rules that do not pass supervised feature importance tests, such as for XGBoost, and/or filtering of rules that do not pass unsupervised feature importance tests, such as for isolation forest, with SHAP values and/or SHAP feature importance. Thereafter, rule selection 134 may create a subset of qualifying rules based on constraints including a predefined alert rate with a programmatic solution to the knapsack problem. An analysis and optimization 136 may then be performed prior to ruleset outputs 138 provided to devices or servers of users and/or entities for review, evaluation, and selection. Analysis and optimization 136 may include individual, marginal, and collective rule analysis for the computing task and alert threshold or effectiveness. Ruleset outputs 138 thereafter provides recommendations including outputs from analysis and optimization 136, such as ruleset suggestions 114 provided to application 112 on client device 110. This allows selection and configuration of programmatically generated decision rules with ML engines.

One or more client devices and/or servers (e.g., client device 110 using application 112) may execute a web-based client that accesses a web-based application for ML system 120, or may utilize a rich client, such as a dedicated resident application, to access ML system 120, which may be provided by customer applications 122 to such client devices and/or servers. Client device 110 and/or other devices or servers may utilize one or more application programming interfaces (APIs) to access and interface with customer applications 122 and/or ML engines 124 of ML system 120 in order to schedule, review, and execute ML modeling and decision rule generation using the operations discussed herein. Interfacing with ML system 120 may be provided through an application for customer applications 122 and/or ML engines 124 and may be based on data stored by database 126, ML system 120, client device 110, and/or database 116. Client device 110 and/or other devices and servers on network 140 might communicate with ML system 120 using TCP/IP and, at a higher network level, use other common Internet protocols to communicate, such as hypertext transfer protocol (HTTP or HTTPS for secure versions of HTTP), file transfer protocol (FTP), wireless application protocol (WAP), etc. Communication between client device 110 and ML system 120 may occur over network 140 using a network interface component 118 of client device 110 and a network interface component 238 of ML system 120. In an example where HTTP/HTTPS is used, client device 110 might include an HTTP/HTTPS client for application 112, commonly referred to as a “browser,” for sending and receiving HTTP//HTTPS messages to and from an HTTP//HTTPS server, such as ML system 120 via the network interface component.

Similarly, ML system 120 may host an online platform accessible over network 140 that communicates information to and receives information from client device 110. Such an HTTP/HTTPS server might be implemented as the sole network interface between client device 110 and ML system 120, but other techniques might be used as well or instead. In some implementations, the interface between client device 110 and ML system 120 includes load sharing functionality. As discussed above, embodiments are suitable for use with the Internet, which refers to a specific global internet of networks. However, it should be understood that other networks can be used instead of or in addition to the Internet, such as an intranet, an extranet, a virtual private network (VPN), a non-TCP/IP based network, any LAN or WAN, or the like.

Client device 110 and other components in environment 100 may utilize network 140 to communicate with ML system 120 and/or other devices and servers, and vice versa, which is any network or combination of networks of devices that communicate with one another. For example, network 140 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the Internet. However, it should be understood that the networks that the present embodiments might use are not so limited, although TCP/IP is a frequently implemented protocol. Further, one or more of client device 110 and/or ML system 120 may be included by the same system, server, and/or device and therefore communicate directly or over an internal network.

According to one embodiment, ML system 120 is configured to provide webpages, forms, applications, data, and media content to one or more client devices and/or to receive data from client device 110 and/or other devices, servers, and online resources. In some embodiments, ML system 120 may be provided or implemented in a cloud environment, which may be accessible through one or more APIs with or without a correspond graphical user interface (GUI) output. ML system 120 further provides security mechanisms to keep data secure. Additionally, the term “server” is meant to include a computer system, including processing hardware and process space(s), and an associated storage system and database application (e.g., object-oriented data base management system (OODBMS) or relational database management system (RDBMS)). It should also be understood that “server system” and “server” are often used interchangeably herein. Similarly, the database objects described herein can be implemented as single databases, a distributed database, a collection of distributed databases, a database with redundant online or offline backups or other redundancies, etc., and might include a distributed database or storage network and associated processing intelligence.

In some embodiments, client device 110, shown in FIG. 1, executes processing logic with processing components to provide data used for ML engines 124 of ML system 120 during use of customer application 122, as well as rule generation using rule training platform 130. In some embodiments, this may include providing training data 113 based on data sets to be processed for decision rule generation, such as transaction data for ML fraud detection using ML engines and decision rules for actionable tasks. In one embodiment, client device 110 includes application servers configured to implement and execute software applications as well as provide related data, code, forms, webpages, platform components or restrictions, and other information associated with data sets for decision rules and ML models, and to store to, and retrieve from, a database system related data, objects, and web page content associated with decision rules and ML models. For example, ML system 120 may implement various functions of processing logic and processing components, and the processing space for executing system processes, such as running applications for decision rule generation and/or ML modeling. Client device 110 and ML system 120 may be accessible over network 140. Thus, ML system 120 may send and receive data to client device 110 via network interface component 128. Client device 110 may be provided by or through one or more cloud processing platforms, such as Amazon Web Services® (AWS) Cloud Computing Services, Google Cloud Platform®, Microsoft Azure® Cloud Platform, and the like, or may correspond to computing infrastructure of an entity, such as a financial institution.

Several elements in the system shown and described in FIG. 1 include elements that are explained briefly here. For example, client device 110 could include a desktop personal computer, workstation, laptop, notepad computer, PDA, cell phone, or any wireless access protocol (WAP) enabled device or any other computing device capable of interfacing directly or indirectly to the Internet or other network connection. Client device 110 may also be a server or other online processing entity that provides functionalities and processing to other client devices or programs, such as online processing entities that provide services to a plurality of disparate clients.

Client device 110 may run an HTTP/HTTPS client, e.g., a browsing program, such as Microsoft's Internet Explorer or Edge browser, Mozilla's Firefox browser, Opera's browser, or a WAP-enabled browser in the case of a cell phone, tablet, notepad computer, PDA or other wireless device, or the like. According to one embodiment, client device 110 and all of its components are configurable using applications, such as a browser, including computer code run using a central processing unit such as an Intel Pentium® processor or the like. However, client device 110 may instead correspond to a server configured to communicate with one or more client programs or devices, similar to a server corresponding to ML system 120 that provides one or more APIs for interaction with client device 110 in order to submit data sets, select data sets, and perform rule modeling operations for an ML system configured for fraud detection.

Thus, client device 110 and/or ML system 120 and all of their components might be operator configurable using application(s) including computer code to run using a central processing unit, which may include an Intel Pentium® processor or the like, and/or multiple processor units. A server for client device 110 and/or ML system 120 may correspond to Window®, Linux®, and the like operating system server that provides resources accessible from the server and may communicate with one or more separate user or client devices over a network. Exemplary types of servers may provide resources and handling for business applications and the like. In some embodiments, the server may also correspond to a cloud computing architecture where resources are spread over a large group of real and/or virtual systems. A computer program product embodiment includes a machine-readable storage medium (media) having instructions stored thereon/in which can be used to program a computer to perform any of the processes of the embodiments described herein utilizing one or more computing devices or servers.

Computer code for operating and configuring client device 110 and ML system 120 to intercommunicate and to process webpages, applications and other data and media content as described herein are preferably downloaded and stored on a hard disk, but the entire program code, or portions thereof, may also be stored in any other volatile or non-volatile memory medium or device, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

### Suggested Solutions for Decision Rule Generation

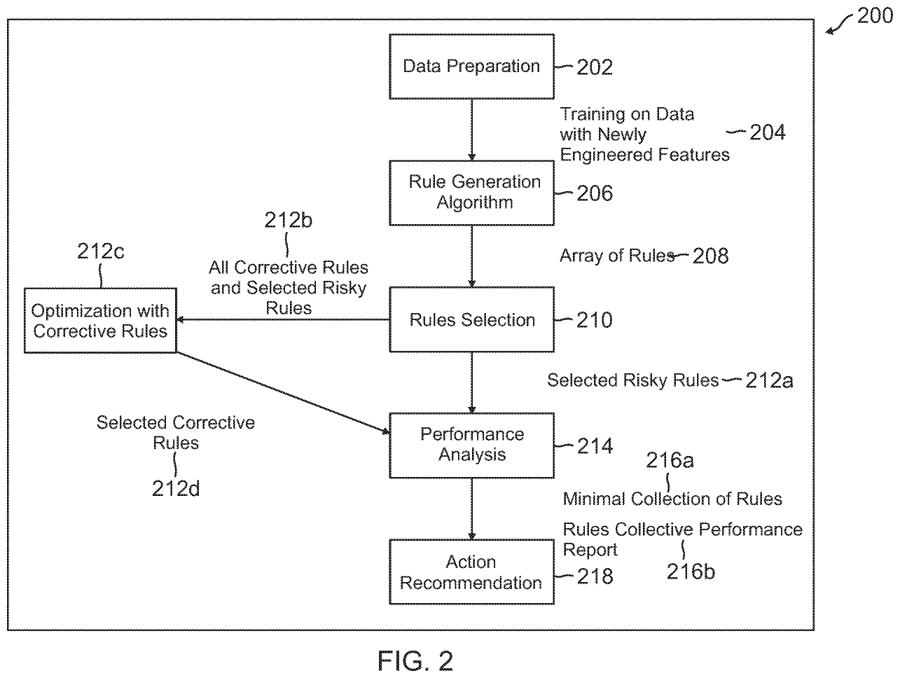

FIG. 2 is a simplified diagram of a computing pipeline to programmatically generate decision rules using ML operations according to some embodiments. Diagram 200 of FIG. 2 includes a data processing pipeline and flow for ML operations that programmatically generate and provide decision rules for ML engines and ML model outputs, such as those decision rules and rulesets provided by ML system 120 to client device 110 discussed in reference to environment 100 of FIG. 1. In this regard, diagram 200 displays processes for ML decision rule generation for decision rules utilized by an ML or other AI system, such as ML engines 124 of customer application 122 from environment 100. Thus, the processes in diagram 200 may be utilized to perform decision rule generation in a programmatic manner without user input and/or intervention using supervised and unsupervised ML algorithms and techniques.

An ML model may be trained using one or more ML algorithms and historical or other training data to provide intelligent outputs, such as classifications, decision-making, predictions and the like in an automated manner without user input and intelligence. These models attempt to mimic human thinking by learning from the past historical training data or other data records of use. Decision rules may be generated in a manner similar to ML model training and may be generated from decision trees similar to tree-based ML models. Thus, rules generation may be based on a tree model where each decision path from the “root” of the tree to a “leaf” may serve as a rule. The rule's maximum complexity may be given by the tree's maximum depth. For rule selection and/or ruleset generation, an objective of the operations described herein may include generating a minimal set of rules that have an optimal accumulated performance under a given alert rate constraint and/or other constraint(s) or task alert and performance metrics. Such metrics may be based on both DRs and VDRs of the rules.

During training, features considered for model and/or rule inclusion may be determined, such as those features available to an ML platform's decision processes at a time of execution (e.g., available to an ML model trainer and/or decision platform of a service provider). This may include a variety of features describing the transaction and/or the party initiating the transaction, which may be based on selected ML features (also referred to as variables) of the transaction used for ML model training. Feature engineering may be performed by using domain knowledge to extract features from raw data (e.g., variables) in the training data set. For example, data features may be transformed from specific transaction variables, account or user variables, and the like. Features may be based on business logic and/or may be selected by a data scientist or data or product analyst. During feature engineering, features may be identified and/or selected based on historically aggregated data for observations and/or transactions. For unsupervised learning and isolation forest algorithms, the number of features may be reduced for training by using the most important features according to an XGBoost model and training data. However, if labels are available for the data, those labels may also be used for hyperparameter optimization by the unsupervised model for selection of decision trees.

In this regard, during process 202, data preparation occurs, which may be based on input training data for ML algorithmic processing at process 204. During process 202, a data set, such as one containing financial transactions for fraud alerts and detection (although other data may also or instead be used), is split into different time-consecutive tables. In one embodiment, this may be three time-consecutive tables, such as a first one for training the model and generating rules, a second one for select the “best” or most optimized rules for the task, alert rate, value, etc., and/or a third one for evaluating the performance of the selected rules. Feature engineering may be applied to the tables, which may include a process for creating new features based on several transformation that are applied to the raw features (e.g., dividing a “current transaction amount” feature by an “account available balance” feature). Additionally, different combinations of values of the tree model hyperparameters may be checked to find optimal parameters that maximize rule performance for the task, whether that is DR, VDR, target alert rate, or the like. Thus, process 202 may include training data splitting (e.g., into test, validation, and evaluation time-consecutive groups), feature engineering, and/or model hyperparameters optimization.

Further operations, such as data enrichment, may occur during preprocessing of data sets. Data enrichment may obtain additional information in the training and/or testing data sets. Data bagging may occur by taking a relative sample size of all features for rule generation (e.g., 100 features where the ML algorithm for rule generation may include more features from data set variables). Data bagging then trains and/or tests different rules, each configured with the corresponding features. Sampling of different transactions or other data points that are labeled may also be performed to reduce system bias with uneven data sets. During training and testing, including data bagging, the data points in each data set for training and testing may be excluded for each other to check accuracies and precisions. Other preprocessing may include data cleaning, sampling, normalizing, determining intersecting columns between data sets, and the like.

Thereafter, one or more decision rules may be trained in this manner and using operations and algorithms similar to decision tree ML model training during a process 204 by applying a rule generation algorithm at process 206. For example, with decision trees, there may be inputs for those features to provide an output classifier, such as a classification of transaction fraud. Decision trees may include different branches and layers or decisions to each branch, such as an input layer, one or more branches with computational nodes for decisions that branch or spread out, and an output layer, each having one or more nodes, however, different layers, branches, and/or nodes may also be utilized. For example, decision trees may include as many branches between an input and output nodes and/or layers as necessary or appropriate. Nodes in each branch and layer may be connected to further nodes to form the branches. In this example, decision trees receive a set of input values or features and produce one or more output values, such as risk scores and/or fraud detection probability or prediction. However, different and/or more outputs may also be provided based on the training. When decision trees are used to, each node in the input layer may correspond to a distinct attribute or input data type derived from the training data.

In some embodiments, each of the nodes in a branch, when present, generates a representation, which may include a mathematical computation (or algorithm) that produces a value based on the input values of the input nodes. The mathematical computation may include assigning different weights to each of the data values received from the input nodes. The branch nodes may include one or more different algorithms and/or different weights assigned to the input data and may therefore produce a different value based on the input values. The values generated by the nodes may be used by the output layer node to produce an output value. When an ML model is used, a risk score or other fraud detection classification, score, or prediction may be output from the features. ML models for decision trees may be separately trained using training data during iterative training, where the nodes in the branches may be trained (adjusted) such that an optimal output (e.g., a classification) is produced in the output layer based on the training data.

The algorithm for supervised learning at process 206 may correspond to XGBoost, whereas the algorithm for unsupervised learning at process 206 may correspond to isolation forest, which may be used for anomaly detection tasks. With unsupervised learning, isolation forest may be used for fraud transaction identification as the anomalous samples in the training data may correspond to the fraudulent transactions as being different, outliers, or anomalous in the training data (e.g., unique and rare without having to profile the samples). Each branch in an ML model tree may correspond to a distinct decision rule and may be used during a process 208 to generate an array of rules. Process 208 may create different rules and therefore provide a rule generation from such tree-based models. The rule generation process for the output array of rules at process 208 using the tree-based algorithm may rely on an iterative algorithm and training with two main variations as described below. Having different variations may allow more flexibility in adjusting to different data sets. Additionally, the variations may be combined to generate a larger and richer set of rules. Both variations may share the concept of focusing in every iteration on improving the trained ML models' errors (e.g., errors caused by the decision tree, from which decision rules may be determined from corresponding branches) from the previous iteration of the corresponding ML model. This may be done by modifying the training data in every iteration to provide more weight or more prevalence to misclassified samples and/or missed positive samples.

In this regard, the algorithm for rule generation (e.g., ML model training for the decision trees from process 206) may output the array of rules during process 208 by performing an iterative training, evaluating, and refining rule generation scheme. For example, during the train phase, a shallow tree model may be trained, and the features may be sampled for each level or layer of the tree to obtain a different tree during each sampling. Rules may be output to the evaluation phase, where a best N number of rules are selected based on their performance in evaluation a part of the validation data from the training data set (e.g., a sample of legitimate transactions and fraudulent transactions). Thereafter, the “best” or optimized rules are provided to a refinement phase. The refinement phase may apply the selected rules or just part of them (e.g., the best performing) on the training data (or just on the fraudulent transactions from the training data) and removing fraudulent samples that the rules found or reweighing all samples according to rules performance. Thus, the training data may be modified in every iteration in a way that gives more weight or prevalence to the misclassified samples, or more specifically, the missed positive samples. The best rules may be selected based on an alert rate (AR) less than the target or threshold AR, a lift ratio (e.g., a ratio measured as a percentage of fraud transactions identified by a given rule divided by the AR for that threshold) that is higher than a predefined configured value, and/or correctly detecting a minimum number of fraud cases based on a predefined threshold. Stopping criteria for the iterative training and rule generation may include identifying when the model performance, measured as misclassification error, is not improved for five (or another set number) of iterations, once all frauds in the training data sets are discovered, and/or once fifteen (or another set number) of consecutive models are unable to produce the performance level that has been preestablished.

At process 210, rules selection may be performed for decision rules from the ML model trees based on the validation data. This may consist of two stages represented by processes 212a-d. For supervised and unsupervised ML model and decision tree learning for rule generation and selection, both may be performed using the validation data through filtering and optimal rules subset selection. For example, at processes 212a and b, filtering may be performed for the supervised ML model's rules based on the performance of each rule, where criteria for passing the filter may include an AR less than the target AR defined by the user, a lift ratio greater than a predefined threshold (where a default may be three or similar), correctly classifying a number of frauds equal to or great than a certain predefined threshold, frauds detected in at least a set number or portion of the time periods within the validation data set, passing a stability test (e.g., evaluating rules performance for precision and ensuring that there are no material fluctuation when evaluating against both the “train” and “validation” data sets), or other filtering criteria. Similar operations may be performed for unsupervised ML model rules, where filtering may leave rules that have complexity and AR lower than target values and higher than a minimum threshold, as well as those that passed a stability test.

Selection during processes 212a and b may utilize operations to rank the rules. Rules may be ranked according to different measures and then selected, where an algorithm for solving the knapsack problem may be implemented with dynamic programming for rule selection. For XGBoost and supervised learning for ML model rules, rules may be ranked according to several key performance indicators (KPIs) that are used in fraud detection or other ML task to maximize DRs and/or VDRs. For DR, the measure may be an XGBoost feature importance score. The score may be calculated by training an XGBoost model on the data set containing the results of applying the rules on the validation data set. In this data set, the rows may represent individual transactions or other data records, and the columns may represent the various rules, so that every cell within that data set contains the result of applying a rule on a transaction or other data record from the validation data set. Each row may therefore have a binary value or one of two values, 0 (e.g., if the transaction is legitimate) or 1 (e.g., if the transaction is fraudulent). Thus, the rules serve as input features for the model that attempts to predict the true label of a transaction or other data record given the rules' predictions. An XGBoost model may rank each feature's contribution to the creation of the final model resulting in a measure representing each rule's contribution to overall detection. For DR, another measure may be a false positive ratio, measured as the ratio between the number of false alerts that the rule produces (false positives) and the true positives that the rule discovers. The lower the ratio implies high precision of the model and rule, and therefore the higher the rule is ranked. For VDR, the measure may include an “amount lift” calculated as the value DR divided by AR. The higher value of the ratio, the higher the efficiency of the rule and therefore ranking. Thus, for VDR, the higher the rating or score, the overall better performance of the rule.

The second method for ranking and selection may be a dynamically programmed solution to the knapsack problem. This is a problem in combinatorial optimization, where given a set of items, each with a weight and a value, there is a determination of how many items from each category may be included in a collection of items so that the total weight is less than or equal to a given limit, and the total value is as large as possible. It derives its name from a problem faced by someone who is constrained by a fixed-size knapsack and must fill it with the most valuable items. The 0-1 knapsack problem may be most relevant, which restricts the number of copies of each kind of item to zero or one, such as a “take” or “do not take” outcome for each item (e.g., rule) when adding to the knapsack (e.g., ruleset and/or selection of rules that is constrained by an overall allowable AR or other constraints). Each rule has a “weight” defined as the rule's AR and a “value” defined as the rule's VDR. The total weight, the knapsack capacity, is the overall AR that is afforded to the detection process and/or system. The 0-1 knapsack problem may be solved using a dynamic programming approach where the larger problem is broken or divided into smaller sub-problems so that the optimal solution to one sub-problem leads to an optimal solution to a bigger sub-problem and so on until the optimal solution for the whole problem is reached. Dynamic programming may yield a table having: [number of filtered rules, alert rate], which holds, in the last row, the optimal subset of rules for the defined capacity or threshold and for every capacity below it. With overlapping rules, input may be provided to the dynamic programming implementation for a target capacity, such as a summative alert rate, which is higher than a desired one. Thereafter, the system may search for the last row that satisfies the criteria of maximum capacity (e.g., a target alert rate for all rules collectively).

With unsupervised learning and isolation forest ML model rules, two processes may also be used for rule ranking during rule selection at process 210. For example, for each rule, a subset of samples on which the rule fires (e.g., triggers an alert) may be examined and statistics (e.g., a sum, mean, median, standard deviation, etc.) may be calculated for the anomalous scores that the samples obtained using the full isolation forest ML model tree (e.g., all decision trees' combinations, as opposed to the rules which are based each on a single tree only). The scores may be normalized to be on a scale of 0 to 1 and, for each rule, another score is obtained based on the scores of the transactions or other data records that the rule was triggered on, which may be calculated using the following Equation 1:

$$score = \overline{x} - \frac{std}{\sqrt{n}} \qquad Equation 1$$

Where x bar denotes the mean of the normalized anomaly scores, std is the standard deviation of these scores, and n denotes the number of transactions where the rule caused an alert to be created. Thus, rules with higher scores may rank higher. The second process may include training another model using another algorithm for anomaly detection (e.g., one class SVM, LOF, DBSCAN, etc.), which is used to produce anomaly scores for the validation data. Then a Pearson correlation between a rule's predictions and the algorithm's prediction may be calculated and rules with higher correlation may be ranked higher. The algorithm may be selected based on performance on past data. Both of the above processes may be combined into one score by a weighted average reflecting the quality or weight given to each process.

At process 212c, optimization with corrective rules may be performed to select corrective rules that may be applied during a process 214 for performance analysis and application to risky rules. Corrective rules may be those that have a lift ratio less than a predefined threshold extracted during training and reevaluated later on the validation data. The corrective rules may be used to offset the risky rules' false positive triggers whenever they overlap with the corrective predictions, thus reducing the overall false positive rate. The generation algorithm may discover many corrective rules, so a subset of the corrective rules may be selected to reduce their number to the optimal minimum. This may be done via an iterative process that checks the overlap between risky rules' predictions and corrective rules' predictions, then selecting the corrective rule with the most advantageous overlap (e.g., maximizes the difference or delta between false positives to true positives). Thereafter, these predictions may be removed from the data and may repeat the process until no advantageous overlapping rules remain.

Thus, selected corrective rules are provided from process 212d for process 214 that executes a performance analysis and further optimizes rule and ruleset selection. For supervised learning and labeled data, after selecting one of the suggested subsets of rules during rules evaluation and other performance analysis at process 214, performance is analyzed to understand the contribution of each of the selected rules to the collective performance. That is, what is the added value that is gained by including each rule individually, marginally, and/or collectively. This provides a rule importance estimation and reduces the number of selected rules. By implementing a “greedy” approach, such as by making locally optimal choices at each stage (e.g., by minimizing or maximizing local choices, objective functions, etc.) with the desired outcome of having a global optimum, for rules selection, rules that were identified as contributing to overall performance increase when selected may be proven redundant during performance analysis after all the rule combinations are evaluated.

For unsupervised learning and unlabeled data, the unique contribution of each rule to the collective AR may be calculated. Due to the lack of labels, it would be impossible to calculate DR and therefore AR as the main target KPI. A dimensionality reduction unsupervised algorithm used for visualizing the structure of high dimensional data in two or three dimensions may be used, such as t-SNE. By projecting the test data and validation data into the two-dimensional space, the predictions of the rules may be evaluated by estimating how anomalous they are, how far they are from another cluster or a cluster of importance (e.g., based on size, numerosity, correlated data, etc.), or the like.

Further, model explanation may be performed to understand the importance of features in each model and the importance of the features to the models. Thus, after building the models and rules, an ML model explainer, such as an explanation algorithm, may be used to verify the added value of each separate feature. This may be used with XGBoost for supervised learning algorithms or isolation forest for unsupervised algorithms, where SHAP may also be applied to obtain a measure of importance of each feature in each classification task. SHAP is applied to provide explanation of the model and rules from SHAP values. Calculation of SHAP or Shapley values may be performed using the following Equation 2:

$$T : feature space \\ p : cardinality of feature space \\ v = v ( T ) : total feature contribution through feature space , \\ among features \\ {φ}_{x} ( v ) : shapely value that is a share given to each feature m \\ S : subject of T after excluding feature m \\ k ( S ) : size of S \\ v ( S ) : value achieved by subset S \\ v ( S ⋃ \{ m \} ) : realized value after feature m joins S \\ \begin{matrix}{φ}_{x} ( v ) = \frac{1}{P} \sum \frac{v ( S ⋃ \{ m \} ) - v ( S )}{( \begin{matrix}p - 1 \\ k ( S )\end{matrix} )} & m = 1 , 2 , 3 , … , p\end{matrix} \qquad Equation 2$$

After process 214 for performance analysis, a process 216a may provide a minimal collection of rules, while a process 216b provides a rules collective performance report, which allows for action recommendation. The minimal collection of rules and rules collective performance report from processes 216a and b may be used to generate action recommendations at a process 218 that may include which action to take for each combination of rules that may fire, alert, or otherwise trigger (e.g., alert generation, block a transaction, delay a transaction, etc.). The recommendation may be based on a combination of the rules' performance in the “validation” and “test” dataset, which may be translated into an action recommendation according to specific criteria predefined by the client, system, task, or the like. For example, if a certain rule subset has a DR higher than a threshold and a false positive rate lower than a threshold in both the validation and test dataset, then the corresponding transaction causing the triggering of the rule and/or ruleset may be blocked in real-time. Similarly, once a rule or ruleset is deployed by the financial institution with its recommended action, the transaction will automatically be blocked by the core banking system thereby preventing fraud in real-time. The final output of the tool may be a policy structure of the suggested rules which can easily be ingested into a policy manager application using a visual interface along with the suggested actions for those rules. Rules can be activated and used in real-time to alert, decline a transaction, challenge a user for further authentication, or the like on triggered transactions to prevent fraud in real-time, or provide other ML outputs and actions. The system may provide action recommendations for every rule or ruleset that may be triggered, such as a recommendation to use a rule combination with very low false positive rates for declining transactions in real-time.

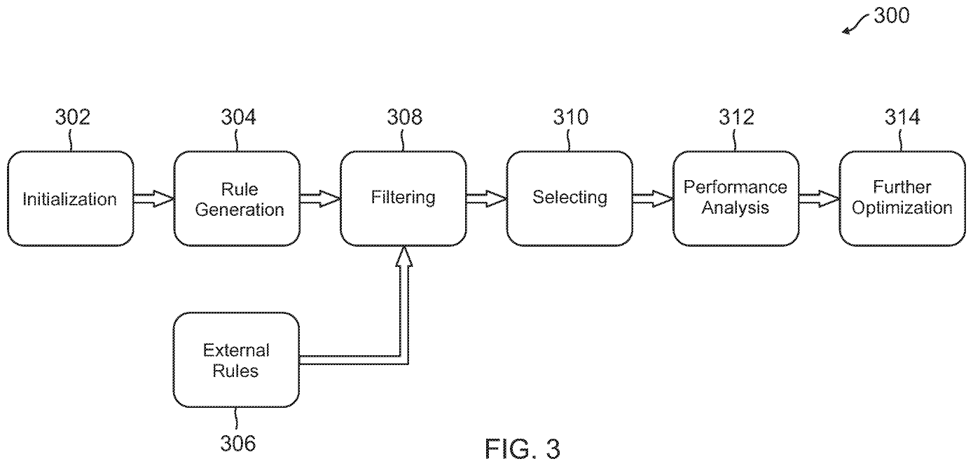

FIG. 3 is a simplified diagram 300 of modular operations executed by an ML engine for programmatically generating decision rules according to some embodiments. Diagram 300 of FIG. 3 includes ML operations that programmatically generate and provide decision rules for ML engines and ML model outputs, such as those decision rules and rulesets provided by ML system 120 to client device 110 discussed in reference to environment 100 of FIG. 1. In this regard, diagram 300 displays a pipeline of such operations that may be performed during rule generation, selection, analysis, and recommendation based on ML operations performed on a rule training dataset.

For an initialization module 302, data is obtained and preprocessed for ML model and decision rule training (e.g., generation of decision trees from which decision rules may be determined). Thus, a data set for training, validation, and testing may be obtained from an overall rule training dataset. Global parameters may be implemented for the ML rule training dataset, while other data preparations steps may be implemented including feature engineering and configuration for training. Further, the ML model used in production may be evaluated for use with the ML pipeline and operations to programmatically generate decision rules.

For a rule generation module 304, ML model training and rule generation is performed based on ML decision trees and branches of such trees. These may be generated using XGBoost for supervised training and labeled data, for example, using XGBoost parameters and a scoring function with training and validation datasets for iterative model training. For unsupervised training and unlabeled data, isolation forest training may be used, which may also utilize iterative training to optimize decision trees and branches based on the training and validation datasets. Thus, a training, evaluating, and refining operation may be implemented. Variations may include sampling during training, real ADABoost where a best rule is picked and weights adjusted to train according to performance, a validation reduction to remove frauds discovered from validation, and configurations to model and selection parameters.

Optionally and/or at a later time, external rules may be applied by an external rules module 306, which is utilized by a filtering module 308 to provide additional operations for filtering of the rules individually and/or for rulesets. Performance of each rule is calculated by filtering module 308 separately on the validation data and filtering may be done by AR, where a minimum number or threshold of frauds (or other data records) may be required to be detected and/or alerted during individual time periods for the validation data. Stability filtering may also be implemented to compare training to validation data and compare different folds or portions of the validation data against each other by the rules. This allows filtering of rules that deviate in both comparisons.

A selecting module 310 is then utilized to select rules and/or rulesets from the filtered decision rules based on the trained ML models and trees. This may include determining and analyzing a rule's individual performance and multiple rules' collective performances, as well as removing correlated rules. Multiple processes may be implemented together, in unison, and/or individually. For example, rules may be ranked according to different measures and then picked in a greedy manner. For DR, XGBoost feature importance scores may be used, whereas for VDR an amount lift may be used. Amount lift may be calculated as the value detection rate divided by the alert rate. Thus, the higher that the ratio is, the higher the efficiency of the rule, and therefore the higher the rule's ranking. Feature importance scores and/or amount lift may be implemented with dynamic programming for an algorithm for solving the knapsack problem. The resulting table may suggest options for rules collections to maximize a target metric for a target AR.

For a performance analysis module 312, a tool may be implemented for analysis of selected rules. Each rule's individual performance may be analyzed on validation and test data. Further, each rule's relative contribution to an AR and metric score may be determined, and a rules correlation analysis may be performed to identify overlapping or overly correlated rules. Diagram 300 ends with an optimization module 314, which may include rule optimization by amount and application of corrective rules. For example, transactions or other data records below a threshold data point may be filtered to reduce an AR or enhance VDR. A selection by amount process may take rule collections and a target AR to find a subset of rules and an optimal alert amount threshold that maximize the metric for that AR. Corrective rules, defined by a lift value less than or equal to a threshold may be used to reduce an alert rate for a selection of risky rules. These may be extracted during training and reevaluated later on validation data.

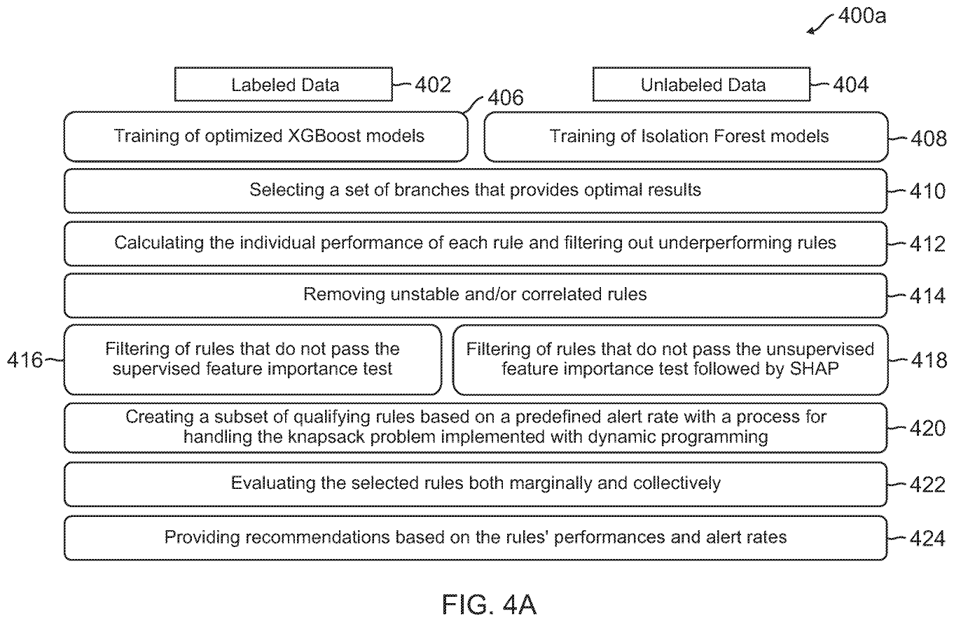

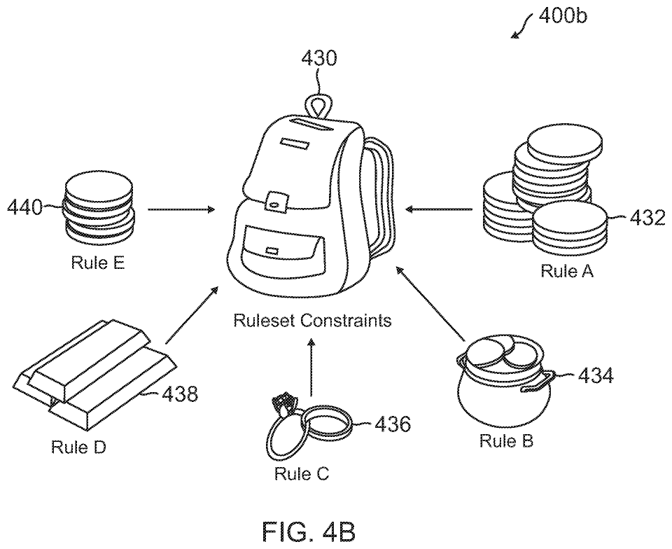

FIG. 4A is a simplified diagram 400a of ML operations using labeled data with supervised ML techniques and unlabeled data with unsupervised ML techniques for decision rule generation according to some embodiments. Diagram 400a of FIG. 4A includes ML operations that programmatically generate and provide decision rules from labeled data 402 and unlabeled data 404, such as those decision rules and rulesets provided by ML system 120 to client device 110 discussed in reference to environment 100 of FIG. 1. In this regard, diagram 400a displays blocks 406-424 for rule discovery, selection, evaluation, and application provided by an ML pipeline that generates decision rules.

For labeled data 402, in block 406, training is performed on a training data set obtained from the overall data set having labeled data 402 for one or more optimized XGBoost or similar models that include ML decision trees. For unlabeled data 404, at block 408, training is performed on a similarly selected training data set from the overall set including unlabeled data 404 for one or more optimized isolation forest or similar models. The models may be iteratively trained for optimization by removing data records causing alerts and/or identified by the models. Thereafter, at a process 210, a set of branches from the trained ML models are selected based on providing optimal results.

Rule selection may then be implemented after rule discovery, where at block 412, individual performance of each rule is calculated so that underperforming rules may be filtered out from the available and generated rules from the ML decision trees. At block 414, unstable and/or correlated rules are further removed, for example, by determining those rules that do not alert on fraud or particular data records that are labeled for detection (with labeled data) or anomalous when compared to the other records (with unlabeled data). Diagram 400a further diverts at blocks 416 and 418 for labeled data 402 and unlabeled data 404, respectively. At block 416 for labeled data 402, rules are filtered that do not pass a supervised feature importance test, such as one determined using the XGBoost model. At block 418 for unlabeled data 404, rules are instead filtered that do not pass an unsupervised feature importance test (e.g., using the isolation forest model), which may be followed by SHAP for feature importance explanation and ranking. Diagram 400b may then again converge for rule selection and ruleset creation, which may utilize dynamic programming for solving the knapsack problem as discussed with regard to FIG. 4B.

FIG. 4B is a simplified diagram 400b of ruleset selection using a knapsack problem solution according to some embodiments. Diagram 400b of FIG. 4B displays the problem that may be solved using dynamic programming at block 420 from diagram 400a of FIG. 4A. For example, at block 420, diagram 400b again converges where a subset of qualifying rules is created based on a predefined alert rate with a process for handling the knapsack problem implemented with dynamic programming.

In diagram 400b, each “item” shown is instead a rule that is required to fit into a “knapsack” that is one or more constraints on rule usage for alerting (e.g., a maximum AR available to the rules and/or ruleset for the system, task, or the like). Diagram 400b includes ruleset constraints 430 that may be used to constrain usage of rules A-E 432-440 during alerting and ML detection tasks (e.g., fraud detection). Thus, each of rules A-E 432-440 have a weight set as their corresponding alert rate and a value set as their corresponding detection rate. The “knapsacks” capacity is the overall afforded or maximum AR based on ruleset constraints 430. Selection of rules, such as rule B 434 with rule C 436 and rule E 440 may provide the best weight to value ratio based on ruleset constraints 430. However, unlike the original problem, the sum of the individual rules' performances may not necessarily be the same as the performance of the collective ruleset due to overlap. Thus, the dynamic programming implementation may provide optimal combinations for any alert rate lower than that defined by ruleset constraints 430 in order to bridge that gap and allow further selection and analysis.

Returning to diagram 400a of FIG. 4A, at block 422, the selected rules are evaluated both marginally and collectively. This allows for determination of the performance of the rules that may be selected individually and/or the generated rulesets for alert detection. An application process may follow, where at block 424, recommendations are provided based on the rules' performance and alert rate. In this regard, the recommendations may include a task or action for use with each combination of rules (e.g., generate alert, block transaction, delay processing, etc.).

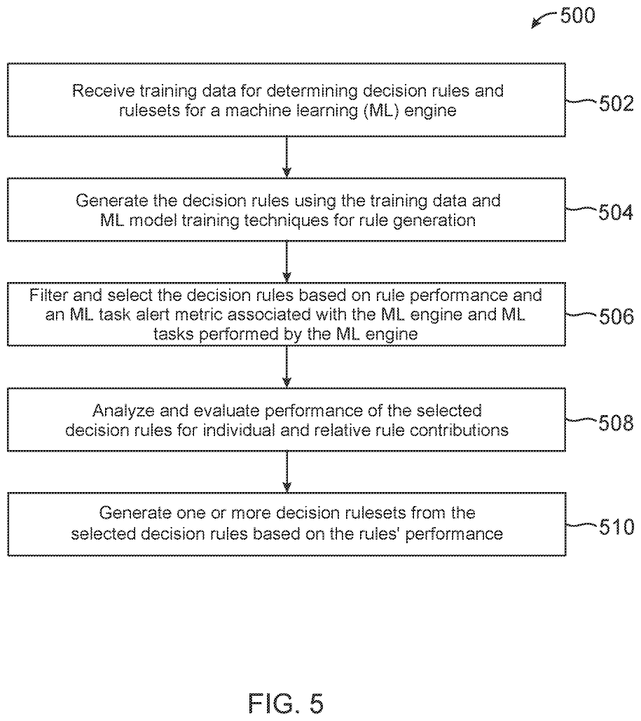

FIG. 5 is a simplified diagram of an exemplary flowchart 500 for programmatically generating decision rules and corresponding rulesets using machine learning operations according to some embodiments. Note that one or more steps, processes, and methods described herein of flowchart 500 may be omitted, performed in a different sequence, or combined as desired or appropriate based on the guidance provided herein. Flowchart 500 of FIG. 5 includes operations for training ML models for decision rule generation, as discussed in reference to FIG. 1-4B. One or more of steps 502-510 of flowchart 500 may be implemented, at least in part, in the form of executable code stored on non-transitory, tangible, machine-readable media that when run by one or more processors may cause the one or more processors to perform one or more of steps 502-510. In some embodiments, flowchart 500 can be performed by one or more computing devices discussed in environment 100 of FIG. 1.

At step 502 of flowchart 500, training data for determining decision rules and rulesets for an ML engine is received. The rule training data may be received for training of the ML model(s) in a supervised or unsupervised manner using labeled or unlabeled data, respectively. Thus, the data set may correspond to a newer or more recent data set. The data set may include data records and/or values for different features of ML model f, which may also be segmented by and/or corresponding to training, validation, testing, and/or other operations. The data set may be received over a course of time for training of the ML model and may include labels or be unlabeled for new or fresh data.

At step 504, the decision rules are generated using the training data and ML model training techniques for rule generation. For example, decision trees may be generated and trained using tree-based ML algorithms and processes, where different “branches” or other decision tree segments, pathways, neurons, or the like represent different decision rules. The decision trees may be iteratively trained by training an initial model and retraining after removing data records or points that have been detected or classified per the ML classification task (e.g., fraud detection). At step 506, the decision rules are filtered and selected based on rule performance and an ML task alert metric associated with the ML engine and ML tasks performed by the ML engine. Filtering may utilize rule performance individually and/or with combinations of other rules, as well as rule removal for correlated or unstable rules. Further, feature importance tests may be applied to filter non-passing rules. Selection may utilize a predefined or maximum AR for the ML classification task and/or ruleset AR allowance (or other ML task alert metric). Selection may further apply a solution to the knapsack problem for rule AR and VDR during selection using dynamic programming.

At step 508, performance of the selected decision rules and relative rule contributions are analyzed and evaluated. For example, rules may be evaluated both marginally and collectively to determine contribution to AR of the ruleset and overlap with other rules. Corrective rules may also be applied to risk rules and/or to reduce the AR of particular rules. At step 510, one or more decision rulesets from the selected decision rules are generated based on the rules' performance. One or more interfaces may be provided for users, teams, entities, or the like to review proposed rules and rulesets for alerting on the ML classification task. Further, the interfaces may display recommended or suggested actions to take in response to the corresponding alert, such as alert generation alone, initiating a computing action, preventing a computing action, or the like. Customers and tenants may then apply the rules and actions to alert detection and generation systems implementing ML models and engines.

As discussed above and further emphasized here, FIGS. 1, 2, 3, 4A, 4B, and 5 are merely examples of ML system 120 and corresponding methods for programmatic decision rule generation using trained ML models, which examples should not be used to unduly limit the scope of the claims. One of ordinary skill in the art would recognize many variations, alternatives, and modifications.

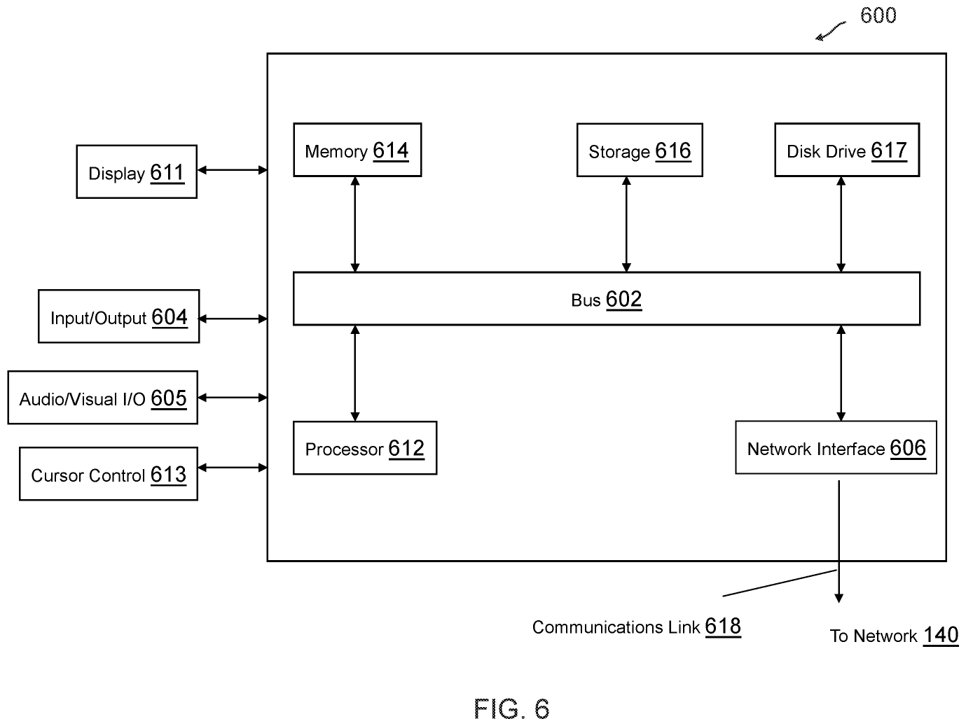

FIG. 6 is a block diagram of a computer system 600 suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals. Audio/visual I/O component 605 may allow the user to hear audio, and well as input and/or output video. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications of the foregoing disclosure. Thus, the scope of the present application should be limited only by the following claims, and it is appropriate that the claims be construed broadly and in a manner consistent with the scope of the embodiments disclosed herein.

What is claimed is:

1. A rule training system configured to automatically generate machine learning (ML) rules for intelligent decision-making by an ML engine, the rule training system comprising:
a processor and a computer readable medium operably coupled thereto, the computer readable medium comprising a plurality of instructions stored in association therewith that are accessible to, and executable by, the processor, to perform rule training operations which comprise:
accessing rule training data for determining a plurality of decision rules for an ML task of the ML engine;
iteratively generating the plurality of decision rules based on the rule training data and a plurality of ML model training techniques associated with the ML engine;
testing each of the plurality of decision rules for a corresponding performance using rule testing data associated with the ML engine;
filtering the plurality of decision rules by the corresponding performances to remove rules underperforming a rule performance threshold, wherein the filtering includes a rule correlation analysis that correlates each rule to one or more other rules to remove two or more rules when meeting or exceeding a threshold correlation;
selecting a set of the plurality of decision rules that maximizes an ML task alert metric within a maximum alert rate for the ML task;
evaluating the set of the plurality of decision rules based on an individual rule performance and a relative rule contribution of each rule in the set to outputs by the set for the ML task; and
generating, based on the evaluating, a decision ruleset for the ML task, wherein the decision ruleset comprises at least a portion of the set of the plurality of decision rules selected and evaluated.

2. The rule training system of claim 1, wherein the rule training data and the ML task are associated with fraud detection and the plurality of decision rules comprise a plurality of fraud detection rules, and wherein the decision ruleset comprises a fraud detection ruleset configured to detect a fraudulent transaction in a transaction processing system.

3. The rule training system of claim 1, wherein the iteratively generating comprises:
applying at least one unsupervised ML model training technique of the plurality of ML model training techniques to unlabeled data from the rule training data; and
determining, based on the applying the at least one unsupervised ML model training technique, at least one unsupervised ML model rule of the plurality of decision rules.

4. The rule training system of claim 3, wherein the iteratively generating further comprises:
applying at least one supervised ML model training technique of the plurality of ML model training techniques to labeled data from the rule training data;
determining, based on the applying the at least one supervised ML model training technique, at least one supervised ML model rule of the plurality of decision rules;
testing the at least one unsupervised ML model rule and the at least one supervised ML model rule separately; and
combining the at least one unsupervised ML model rule and the at least one supervised ML model rule after the testing.

5. The rule training system of claim 4, wherein the at least one supervised ML model training technique utilizes at least one XGBoost model with an iterative data-refinement procedure for iterative training using the labeled data, and wherein the at least one unsupervised ML model training technique utilizes at least one isolation forest model for the iterative training using the unlabeled data.

6. The rule training system of claim 1, wherein the filtering utilizes at least one of a supervised feature importance test or an unsupervised feature importance test for features of the plurality of decision rules, and wherein the selecting the set of the plurality of decision rules is further based on:
limiting alerts generated by the set from meeting or exceeding the maximum alert rate, and
performing a stability test of each rule in the set of the plurality of decision rules.

7. The rule training system of claim 6, wherein the alerts are limited from meeting or exceeding the maximum alert rate using an executable operation that maximizes a detection rate of the set of the plurality of decision rules at or below the maximum alert rate for ones of the plurality of decision rules selected for the set.

8. The rule training system of claim 1, wherein, before generating the decision ruleset, the rule training operations further comprise:
applying at least one corrective rule that filters or masks at least one decision rule of the set from affecting the outputs by the set for the ML task based on false positives by the at least one decision rule.

9. The rule training system of claim 1, wherein the selecting requires a minimum number of decision rules for the set, and wherein the selecting includes:
ranking the plurality of decision rules based on an alert rate and a rule performance analysis for each rule of the plurality of decision rules; and
removing correlated rules from the set.

10. A method to automatically generate machine learning (ML) rules using a rule training system for intelligent decision-making by an ML engine, which method comprises:
accessing rule training data for determining a plurality of decision rules for an ML task of the ML engine;
iteratively generating the plurality of decision rules based on the rule training data and a plurality of ML model training techniques associated with the ML engine;
testing each of the plurality of decision rules for a corresponding performance using rule testing data associated with the ML engine;
filtering the plurality of decision rules by the corresponding performances to remove rules underperforming a rule performance threshold, wherein the filtering includes a rule correlation analysis that correlates each rule to one or more other rules to remove two or more rules when meeting or exceeding a threshold correlation;
selecting a set of the plurality of decision rules that maximizes an ML task alert metric within a maximum alert rate for the ML task;
evaluating the set of the plurality of decision rules based on an individual rule performance and a relative rule contribution of each rule in the set to outputs by the set for the ML task; and
generating, based on the evaluating, a decision ruleset for the ML task, wherein the decision ruleset comprises at least a portion of the set of the plurality of decision rules selected and evaluated.

11. The method of claim 10, wherein the rule training data and the ML task are associated with fraud detection and the plurality of decision rules comprise a plurality of fraud detection rules, and wherein the decision ruleset comprises a fraud detection ruleset configured to detect a fraudulent transaction in a transaction processing system.

12. The method of claim 10, wherein the iteratively generating comprises:
applying at least one unsupervised ML model training technique of the plurality of ML model training techniques to unlabeled data from the rule training data; and
determining, based on the applying the at least one unsupervised ML model training technique, at least one unsupervised ML model rule of the plurality of decision rules.

13. The method of claim 12, wherein the iteratively generating further comprises:
applying at least one supervised ML model training technique of the plurality of ML model training techniques to labeled data from the rule training data;
determining, based on the applying the at least one supervised ML model training technique, at least one supervised ML model rule of the plurality of decision rules;
testing the at least one unsupervised ML model rule and the at least one supervised ML model rule separately; and
combining the at least one unsupervised ML model rule and the at least one supervised ML model rule after the testing.

14. The method of claim 13, wherein the at least one supervised ML model training technique utilizes at least one XGBoost model with an iterative data-refinement procedure for iterative training using the labeled data, and wherein the at least one unsupervised ML model training technique utilizes at least one isolation forest model for the iterative training using the unlabeled data.

15. The method of claim 10, wherein the filtering utilizes at least one of a supervised feature importance test or an unsupervised feature importance test for features of the plurality of decision rules, and wherein the selecting the set of the plurality of decision rules is further based on:
limiting alerts generated by the set from meeting or exceeding the maximum alert rate, and
performing a stability test of each rule in the set of the plurality of decision rules.

16. The method of claim 15, wherein the alerts are limited from meeting or exceeding the maximum alert rate using an executable operation that maximizes a detection rate of the set of the plurality of decision rules at or below the maximum alert rate for ones of the plurality of decision rules selected for the set.

17. The method of claim 10, wherein, before generating the decision ruleset, the method further comprises:
applying at least one corrective rule that filters or masks at least one decision rule of the set from affecting the outputs by the set for the ML task based on false positives by the at least one decision rule.

18. The method of claim 10, wherein the selecting requires a minimum number of decision rules for the set, and wherein the selecting includes:
ranking the plurality of decision rules based on an alert rate and a rule performance analysis for each rule of the plurality of decision rules; and
removing correlated rules from the set.

19. A non-transitory computer-readable medium having stored thereon computer-readable instructions executable to automatically generate machine learning (ML) rules using a rule training system for intelligent decision-making by an ML engine, the computer-readable instructions executable to perform rule training operations which comprise:
accessing rule training data for determining a plurality of decision rules for an ML task of the ML engine;
iteratively generating the plurality of decision rules based on the rule training data and a plurality of ML model training techniques associated with the ML engine;
testing each of the plurality of decision rules for a corresponding performance using rule testing data associated with the ML engine;
filtering the plurality of decision rules by the corresponding performances to remove rules underperforming a rule performance threshold, wherein the filtering includes a rule correlation analysis that correlates each rule to one or more other rules to remove two or more rules when meeting or exceeding a threshold correlation;
selecting a set of the plurality of decision rules that maximizes an ML task alert metric within a maximum alert rate for the ML task;
evaluating the set of the plurality of decision rules based on an individual rule performance and a relative rule contribution of each rule in the set to outputs by the set for the ML task; and
generating, based on the evaluating, a decision ruleset for the ML task, wherein the decision ruleset comprises at least a portion of the set of the plurality of decision rules selected and evaluated.

20. The non-transitory computer-readable medium of claim 19, wherein the rule training data and the ML task are associated with fraud detection and the plurality of decision rules comprise a plurality of fraud detection rules, and wherein the decision ruleset comprises a fraud detection ruleset configured to detect a fraudulent transaction in a transaction processing system.
